(19) United States
(12) Patent Application Publication
(10) Pub. No.: US 2026/0062144 A1
(43) Pub. Date: Mar. 5, 2026

(54) Environmental Control System Based on Unmanned Aerial Vehicle and Unmanned Aerial Vehicle

(71) Applicant: EHANG INTELLIGENT EQUIPMENT (GUANGZHOU) CO., LTD., Guangzhou, Guangdong (CN)

(72) Inventors: Huazhi Hu, Guangzhou, Guangdong (CN); Junhao Yao, Guangzhou, Guangdong (CN); Huipeng Xie, Guangzhou, Guangdong (CN); Xingmin Chen, Guangzhou, Guangdong (CN)

(21) Appl. No.: 19/106,670

(22) PCT Filed: Aug. 8, 2023
(86) PCT No.: PCT/CN2023/111699

§ 371 Date: Feb. 26, 2025

(30) Foreign Application Priority Data
Aug. 31, 2022 (CN) 202211060117.X

(51) Int. Cl. B64D 47/06; H05B 47/155

(52) U.S. Cl. CPC B64D 47/06; H05B 47/155

(57) ABSTRACT

An environmental control system based on an unmanned aerial vehicle and an unmanned aerial vehicle is disclosed. The system includes: a lighting and equipment controller, a lighting driver, a lighting assembly, a fan and a signal input interface. The lighting and equipment controller is used to receive an instruction from an external system, control the lighting driver, the lighting assembly and the fan according to the instruction, and obtain state information of each component in the system through the signal input interface, and feed it back to the corresponding external system. The lighting driver boosts or bucks the power provided by the lighting and equipment controller, and then drives each lighting assembly with a constant current. The lighting and equipment controller controls the operating mode of the lighting assembly and collects the state information of each component under different operating modes.

### TECHNICAL FIELD

The present disclosure belongs to the field of unmanned aerial vehicle technology, and in particular, relates to an environmental control system based on unmanned aerial vehicle and an unmanned aerial vehicle.

### BACKGROUND TECHNOLOGY

With the continuous development of unmanned aerial vehicles, safe operation of unmanned aerial vehicles has become a key issue, especially when flying at night. In order to navigate safely, light signals are required to indicate the state, position and direction of the navigation environment. The existing environmental control system is not interactive, and it is difficult to obtain the real-time state of each lighting assembly, which poses certain safety hazards.

### SUMMARY

### Technical Issue

The purpose of the present disclosure is to provide an environmental control system and an unmanned aerial vehicle based on an unmanned aerial vehicle to solve the safety hazard problem of the night flight of the aerial vehicle caused by the low interactivity of the environmental control system and the difficulty in obtaining the real-time state of each lighting assembly.

### Technical Solution

The technical solution adopted by the present disclosure to solve the above technical issues is as follows:

The present disclosure provides an environmental control system based on an unmanned aerial vehicle, including: a lighting and equipment controller, a lighting driver, a lighting assembly, a fan, and a signal input interface. The lighting and equipment controller is used to receive an instruction from an external system, control the lighting driver, the lighting assembly and the fan according to the instruction, and obtain state information of each component in the system through the signal input interface, and feed the state information back to a corresponding external system; and the lighting driver boosts or bucks power provided by the lighting and equipment controller, and then drives each lighting assembly with a constant current

According to another aspect of the present disclosure, an unmanned aerial vehicle is provided, including the above-mentioned environmental control system, and further including a flight control system, a human-computer interaction system and an electrical system.

### Beneficial Effects

The present disclosure proposes an environmental control system based on an unmanned aerial vehicle and an unmanned aerial vehicle. The system includes: a lighting and equipment controller, a lighting driver, a lighting assembly, a fan and a signal input interface. The lighting and equipment controller is used to receive an instruction from an external system, control the lighting driver, the lighting assembly and the fan according to the instruction, and obtain state information of each component in the system through the signal input interface, and feed it back to the corresponding external system. The lighting driver boosts or bucks the power provided by the lighting and equipment controller, and then drives each lighting assembly with a constant current. The lighting and equipment controller controls the operating mode of the lighting assembly and collects the state information of each component under different operating modes, thereby improving the interactivity of the system, ensuring the safety of night flight of the aerial vehicle, and improving the user experience.

### DESCRIPTION OF THE DRAWINGS

FIG. 1 is a functional block diagram of an environmental control system based on an unmanned aerial vehicle provided in the first embodiment of the present disclosure.

FIG. 2 is an internal electrical connection diagram of an environmental control system provided in the first embodiment of the present disclosure.

FIG. 3 is a special strobe mode working timing diagram provided in the first embodiment of the present disclosure.

FIG. 4 is a working state diagram of a lighting assembly in an aerial vehicle charging state provided in the first embodiment of the present disclosure.

FIG. 5 is a working state diagram of a lighting assembly in an aerial vehicle equipment startup state provided in the first embodiment of the present disclosure.

FIG. 6 is a working state diagram of a lighting assembly in an aerial vehicle power startup state provided in the first embodiment of the present disclosure.

FIG. 7 is a working state diagram of a lighting assembly in an aerial vehicle unlocked state provided in the first embodiment of the present disclosure.

FIG. 8 is a working state diagram of a lighting assembly in an aerial vehicle non-automatic state provided in the first embodiment of the present disclosure.

FIG. 9 is a working state diagram of a lighting assembly in an aerial vehicle maintenance state provided in the first embodiment of the present disclosure.

FIG. 10 is an internal structure diagram of a lighting and equipment controller provided in the first embodiment of the present disclosure.

FIG. 11 is an internal structure diagram of a light driving unit provided in the first embodiment of the present disclosure.

The realization of the purpose, functional features and advantages of the present disclosure will be further explained in conjunction with the embodiments and with reference to the accompanying drawings.

### Implementation Methods

In order to make the technical problems, technical solutions and beneficial effects to be solved by the present disclosure clearer and more understandable, the present disclosure is further described in detail below in conjunction with the accompanying drawings and embodiments. It should be understood that the specific embodiments described herein are only used to explain the present disclosure and are not used to limit the present disclosure.

In the subsequent description, the use of suffixes such as “module”, “component” or “unit” used to represent elements is only to facilitate the description of the present disclosure and has no specific meaning in itself. Therefore, “module”, “component” or “unit” can be used in a mixed manner.

### Embodiment 1

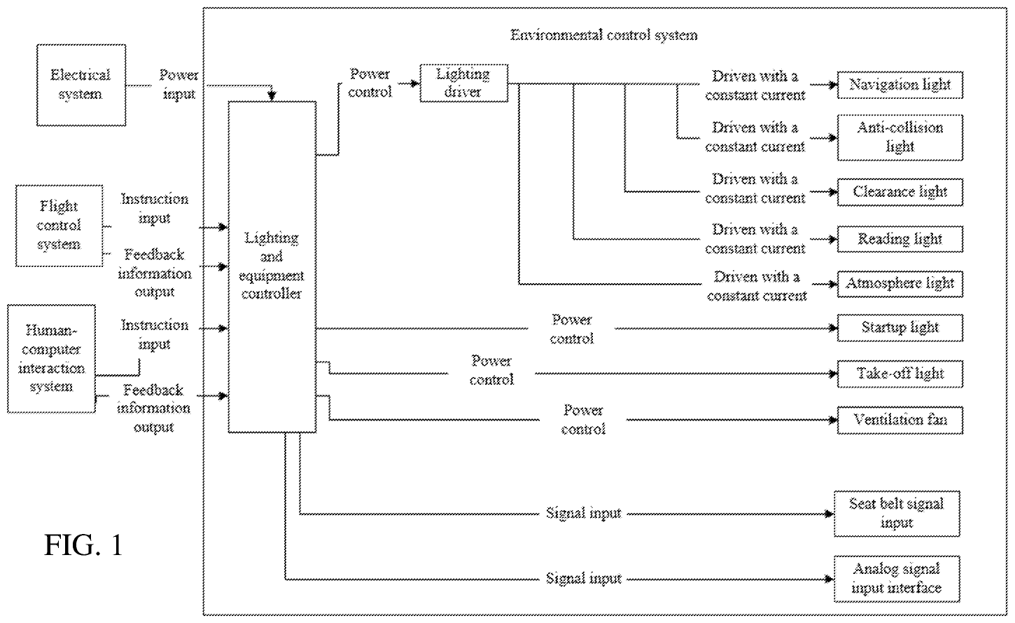

As shown in FIG. 1, in this embodiment, an environmental control system based on an unmanned aerial vehicle includes: a lighting and equipment controller, a lighting driver, a light component, a fan and a signal input interface. The lighting and equipment controller is used to receive instructions from an external system, control the lighting driver, the light component and the fan according to the instructions, and obtain the state information of each component in the system through the signal input interface, and feed it back to the corresponding external system; the lighting driver boosts or bucks the power provided by the lighting and equipment controller, and then drives each light component with a constant current.

In this embodiment, the operating mode of the light component is controlled by the lighting and equipment controller, and the state information of each component under different operating modes is collected, which improves the interactivity of the system, ensures the safety of night flight of aerial vehicle, and improves the user experience.

In this embodiment, the external system includes a flight control system, a human-computer interaction system and an electrical system. Among them, the electrical system is used to provide power to the environmental control system; the flight control system and the human-computer interaction system send control instructions to the environmental control system, and receive the state information fed back by the environmental control system. Together with other systems, they form a complete unmanned aerial vehicle control system to enable the normal operation of the aerial vehicle.

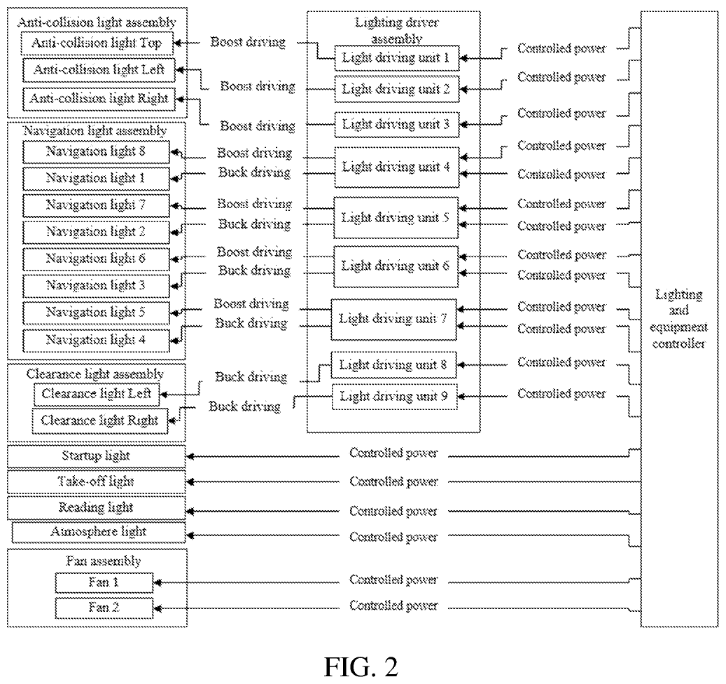

In this embodiment, the electrical connection diagram inside the environmental control system is shown in FIG. 2, where the power output of the lighting and equipment controller is connected to the lighting driver, and the lighting driver is then connected to each lighting assembly, wherein the startup light, take-off light, and fan component are directly connected to the power output of the lighting and equipment controller.

As shown in FIG. 2, in this embodiment, the light component includes: navigation lights, anti-collision lights, clearance lights, reading lights, atmosphere lights, startup lights, and take-off lights, wherein the anti-collision lights include: top anti-collision lights, left rear anti-collision lights, and right rear anti-collision lights, the clearance lights include: left clearance lights and right clearance lights, and the navigation lights include: red navigation lights and green navigation lights.

In this embodiment, the lighting and equipment controller of the environmental control system is the control core of the entire system, which can process instructions from other systems and control the light component according to the instructions, so that the component works in the normally open, special strobe, regular strobe, breathing, dimming, and off modes. At the same time, the component can obtain the working state of each light component and feedback it to other external systems.

The rated voltage of the lighting and equipment controller component is 24V, supports+9-+30V voltage input, the maximum operating current is 15 A, and can work normally in an environment of −20° C.-60° C. The component has 20 controllable 24V power outputs, each of which has an overcurrent protection function. When the output current exceeds 5 A, the output can be disconnected in time. The component has 8 digital signal sampling interfaces and 4 analog signal sampling interfaces, which can sample 0-+5V input signals. At the same time, the component also has 2 parallel CAN communication interfaces, which can communicate information with other systems through CAN.

In this embodiment, the lighting and equipment controller parses the instructions through software and switches the operating mode of the lighting assembly; the operating modes of the lighting assembly include: normally open, special strobe, regular strobe, breathing, dimming, and off.

TABLE 1
Component operating mode correspondence table

| | Normally | Special | Regular | | | |
|---|---|---|---|---|---|---|
| | open | strobe | strobe | Breathing | Dimming | Off |
| Reading | | | | | ✓ | ✓ |
| light | | | | | | |
| atmosphere | | | | | ✓ | ✓ |
| light | | | | | | |
| Top anti- | | ✓ | | | | ✓ |
| collision | | | | | | |
| light | | | | | | |
| Left rear | | ✓ | | | | ✓ |
| anti- | | | | | | |
| collision | | | | | | |
| light | | | | | | |
| Right rear | | ✓ | | | | ✓ |
| anti- | | | | | | |
| collision | | | | | | |
| light | | | | | | |
| Take-off | ✓ | | | | | ✓ |
| light | | | | | | |
| Startup | ✓ | | ✓ | | | ✓ |
| light | | | | | | |
| Red | ✓ | | ✓ | | | ✓ |
| navigation | | | | | | |
| light 2 | | | | | | |
| Red | ✓ | | ✓ | | | ✓ |
| navigation | | | | | | |
| light 3 | | | | | | |
| Red | ✓ | | ✓ | | | ✓ |
| navigation | | | | | | |
| light 4 | | | | | | |
| Red | ✓ | | ✓ | | | ✓ |
| navigation | | | | | | |
| light 5 | | | | | | |
| Green | ✓ | | ✓ | | | ✓ |
| navigation | | | | | | |
| light 1 | | | | | | |
| Green | ✓ | | ✓ | | | ✓ |
| navigation | | | | | | |
| light 6 | | | | | | |
| Green | ✓ | | ✓ | | | ✓ |
| navigation | | | | | | |
| light 7 | | | | | | |
| Green | ✓ | | ✓ | | | ✓ |
| navigation | | | | | | |
| light 8 | | | | | | |
| Left | ✓ | | | ✓ | | ✓ |
| clearance | | | | | | |
| light | | | | | | |
| Right | ✓ | | | ✓ | | ✓ |
| clearance | | | | | | |
| light | | | | | | |
| Fan 1 | ✓ | | | | | ✓ |
| Fan 2 | ✓ | | | | | ✓ |

Among them, the normally open mode means that the component is powered on throughout the whole process.

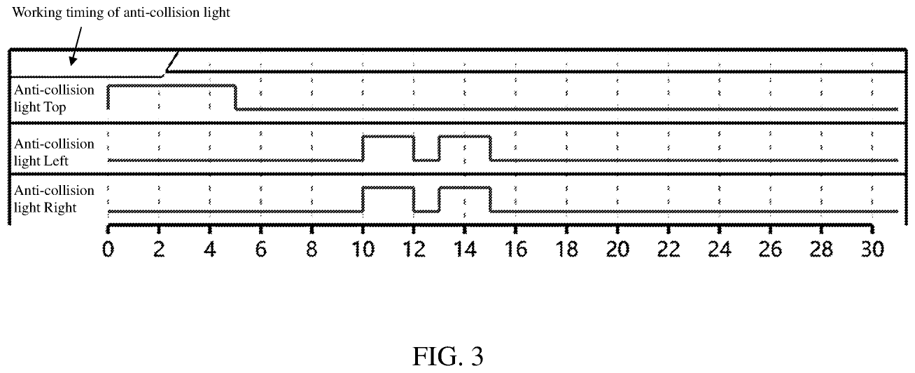

The special strobe mode is unique to the anti-collision lamp, also known as the burst strobe mode, which is manifested as the top anti-collision lamp (also known as the anti-collision lamp top) turns on and off once, and the left rear anti-collision lamp (also known as the anti-collision lamp left) and the right rear anti-collision lamp (also known as the anti-collision lamp right) turn on and off twice at the same time, with a cycle of 3 seconds. The specific working sequence is shown in FIG. 3, where the high level indicates that the power of the lighting assembly is on, the low level indicates that the power is off, the horizontal axis unit is 100 ms, and the working cycle is 3000 ms.

The regular strobe mode means that the power of the component is turned on and off at a set frequency.

The breathing mode means that the component gradually changes from dark to bright and then from bright to dark at a set frequency, where one bright and one dark is a cycle.

The dimming mode means that the component is always on at the set brightness.

The off mode means that the component is not powered on.

In this embodiment, different components have different operating modes, and the correspondence table of operating modes of each component is shown in Table 1 above, where “√” indicates the operating mode that can be supported.

In this embodiment, the operating mode of the lighting assembly corresponds to the navigation state of the aerial vehicle, and the navigation state includes: charging state, equipment startup state, power startup state, unlock state, non-automatic state and maintenance state.

In this embodiment, the system indicates the navigation state of the aerial vehicle by switching the operating mode of each component. The corresponding relationship between the navigation state and the operating mode is shown in Table 2.

TABLE 2
Navigation state and lighting assembly
operating mode correspondence table

| | | lighting assembly operating |
|---|---|---|
| Control source | Navigation state | mode |
| Flight controller | Charging state | Clearance lights are |
| system | | on and off in a |
| | | breathing manner, |
| | | with a frequency of |
| | | 0.2 Hz |
| | | Startup light is always |
| | | on |
| | Equipment startup | Startup light is always |
| | state | on |
| | Power startup | Clearance lights are |
| | state | always on |
| | | Navigation lights are |
| | | always on |
| | | Anti-collision lights |
| | | have special strobe |
| | | Startup light is always |
| | | on |
| | | Fan is running |
| | Unlocked state | Clearance lights are |
| | | always on |
| | | Navigation lights |
| | | alternately and |
| | | regularly strobe, with |
| | | a frequency of 4 Hz |
| | | Anti-collision lights |
| | | have special strobe |
| | | Startup light is always |
| | | on |
| | | Fan is running |
| | Non-automatic | Clearance lights are |
| | state | always on |
| | | Navigation lights all |
| | | strobe regularly |
| | | Anti-collision lights |
| | | have special strobe |
| | | Startup light is always |
| | | on |
| | | Fan is running |
| | Maintenance state | Startup light flashes, |
| | | with a frequency of |
| | | 1 Hz |
| Human-computer | Any state | Reading light dimming, |
| interaction system | | brightness 0-100% |
| | | Atmosphere light |
| | | dimming, brightness |
| | | 0-100% |

In this embodiment, taking the EH216S aerial vehicle as an example, the aerial vehicle navigation state and the operating mode and working state of the corresponding lighting assembly are described in detail.

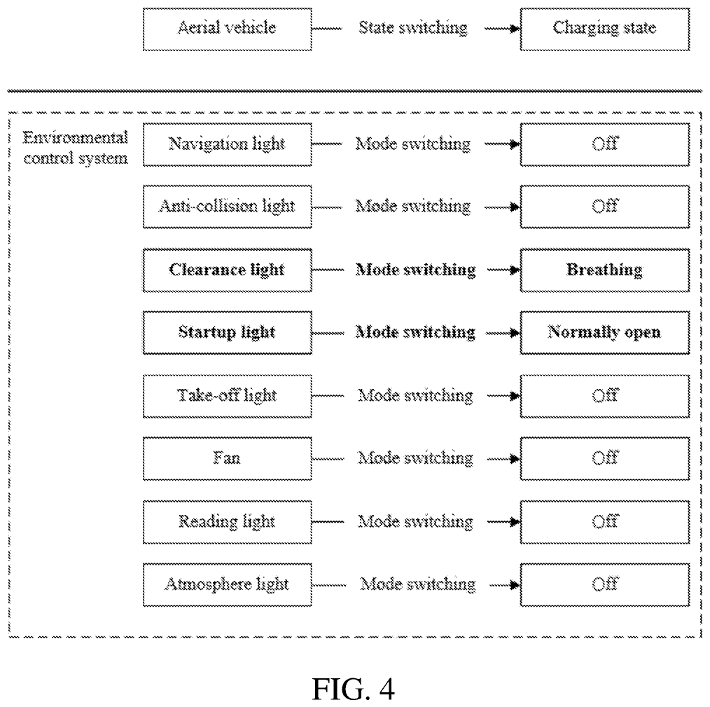

When the EH216S is in the charging state, the clearance lights of the environmental control system are switched to the breathing mode, which is in the breathing light-off state with a frequency of 0.2 Hz, the startup light is switched to the normally open mode, which is always on, and the other lighting assemblies are switched to the off mode. In this state, the reading light and the atmosphere light can be switched to the dimming mode by the human-computer interaction system. Its state is shown in FIG. 4.

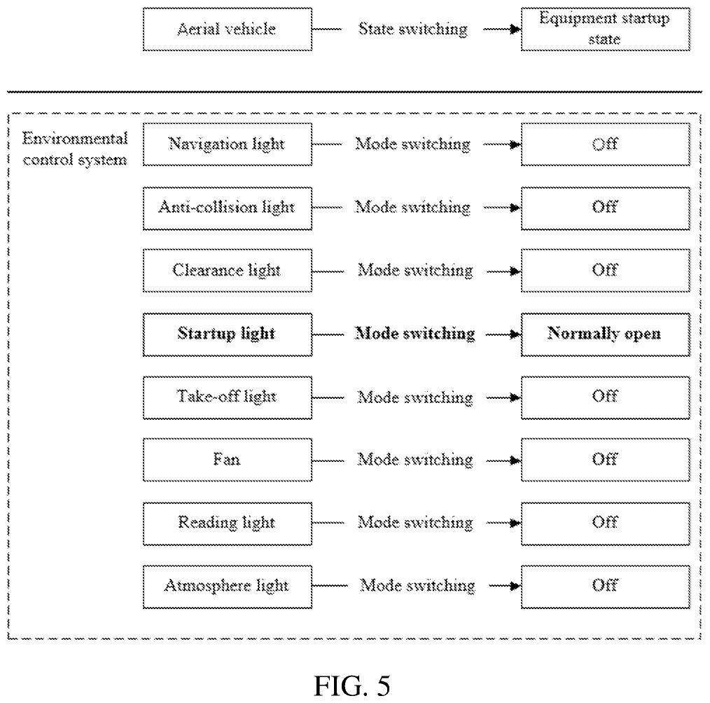

When the EH216S is in the equipment startup state, the startup light of the environmental control system is switched to the normally open mode, which is always on, and the other lighting assemblies are switched to the off mode. In this state, the reading light and the atmosphere light can be switched to the dimming mode by the human-computer interaction system. Its state is shown in FIG. 5.

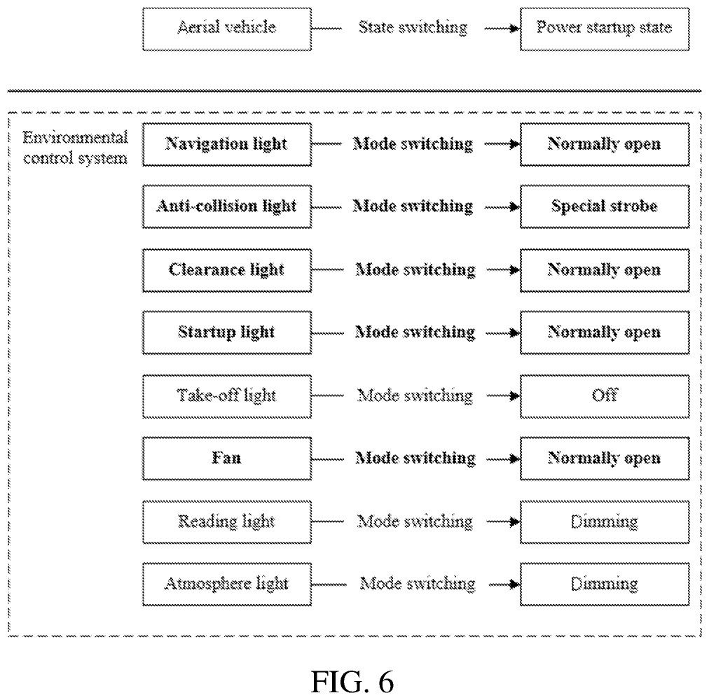

When the EH216S is in the power startup state, the navigation lights of the environmental control system are switched to the normally open mode, which is always on; the anti-collision lights are switched to the special strobe mode; the clearance lights, startup lights, and fans are switched to the normally open mode, and the other lighting assemblies are switched to the off mode. In this state, the reading light and the atmosphere light can be switched to dimming mode by the human-computer interaction system. Its state is shown in FIG. 6.

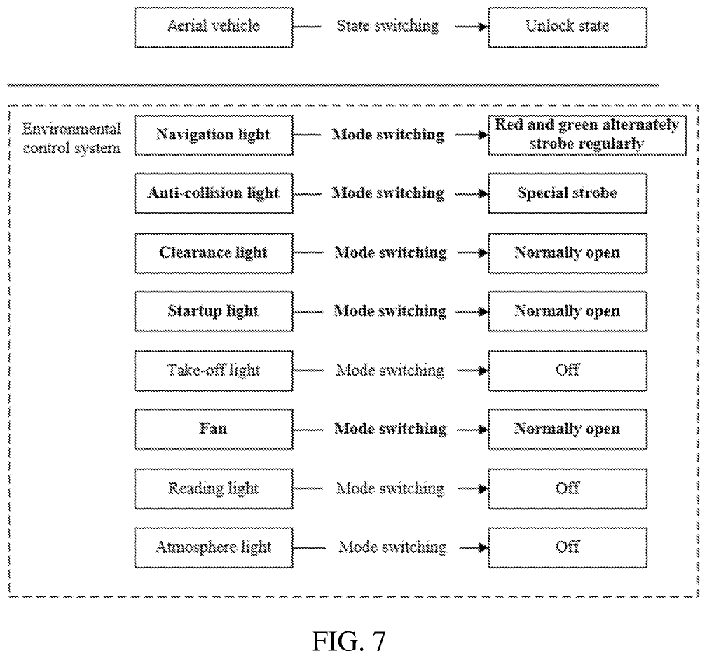

When the EH216S is in the unlocked state, the navigation light of the environmental control system switches to a regular strobe mode, with the red and green navigation lights strobing alternately at a frequency of 4 Hz, and the red and green lights are on and off for 125 ms each; the anti-collision light switches to a special strobe mode; the clearance light, startup light, and fan switch to the normally open mode, while other lighting assemblies switch to the off mode. In this state, the reading light and the atmosphere light can be switched to dimming mode by the human-computer interaction system. Its state is shown in FIG. 7.

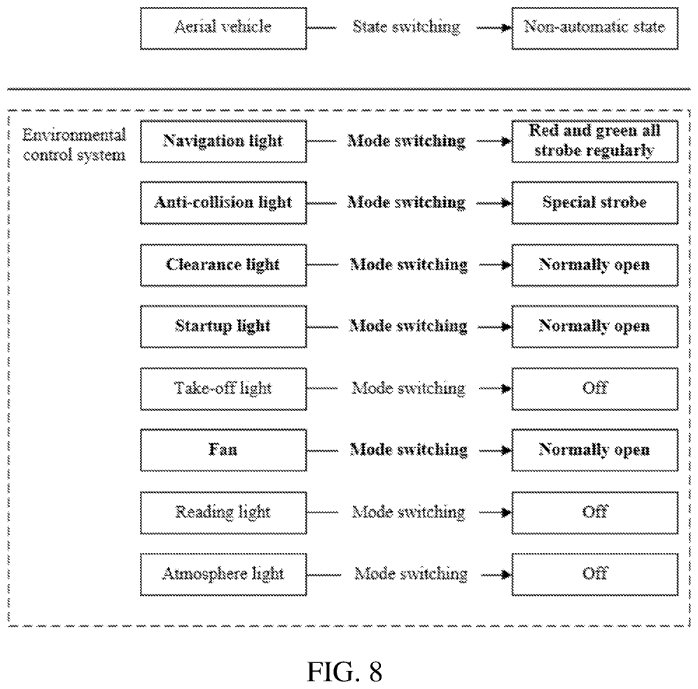

When EH216S is in non-automatic state, the navigation lights of the environmental control system switch to regular strobe mode, the red and green navigation lights strobe regularly at the same time, the frequency is 0.5 Hz, and the red and green lights are on and off at the same time for 2 ms; the anti-collision lights switch to special strobe mode; the clearance lights, startup lights, and fans switch to normally open mode, and other lighting assemblies switch to off mode. In this state, the reading lights and atmosphere lights can be controlled by the human-computer interaction system to switch to dimming mode. Its state is shown in FIG. 8.

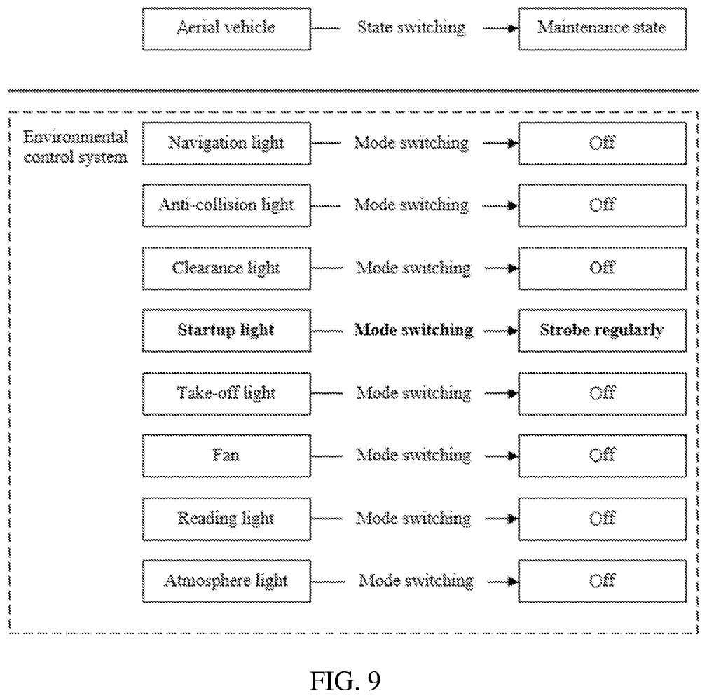

When EH216S is in maintenance state, the environmental control system switches to regular strobe mode with a frequency of 1 Hz, and other lighting assemblies switch to off mode. In this state, the reading lights and atmosphere lights can be controlled by the human-computer interaction system to switch to dimming mode. Its state is shown in FIG. 9.

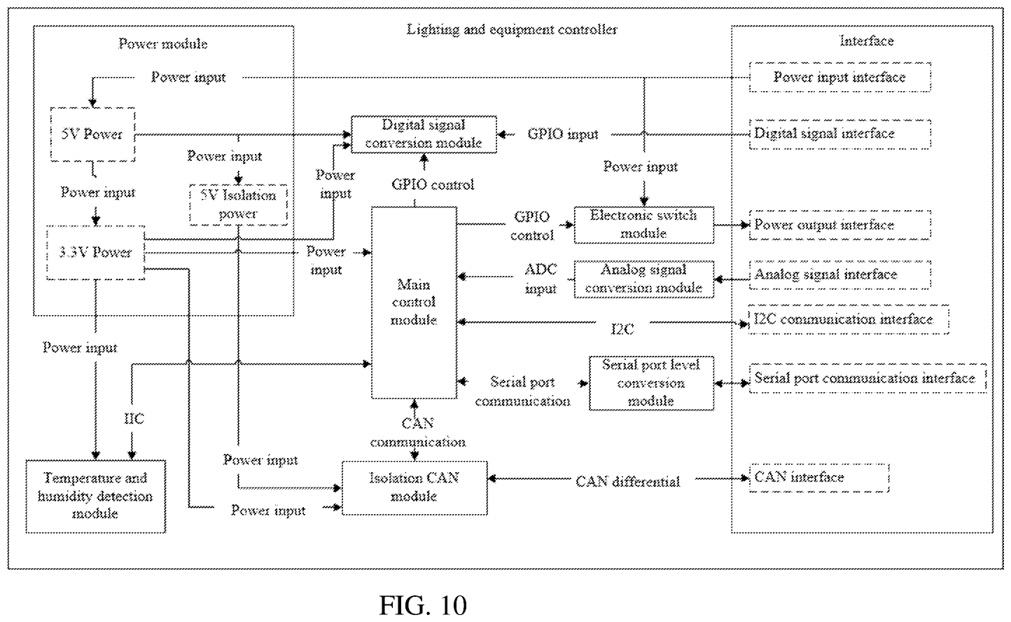

In this embodiment, the lighting and equipment controller includes: a power module, an electronic switch module, an analog signal conversion module, a digital signal conversion module, an isolation CAN module, a serial port level conversion module, a temperature and humidity detection module, a main control module and an interface. Its internal structure diagram is shown in FIG. 10.

In this embodiment, the power module includes 20 controllable 24V power outputs, each of which has an overcurrent protection function; the digital signal conversion module includes 8 digital signal sampling interfaces, and the analog signal conversion module includes 4 analog signal sampling interfaces.

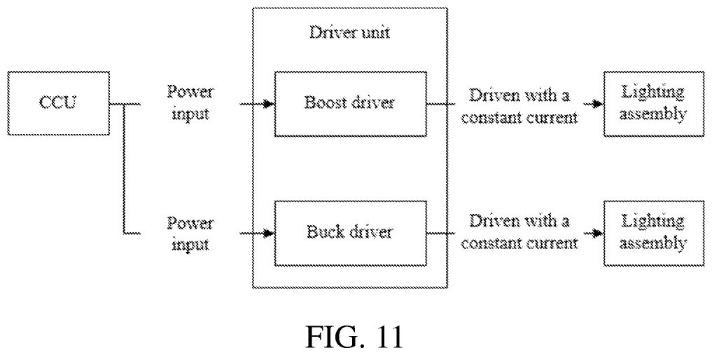

In this embodiment, the function of the lighting driver component of the environmental control system is to drive the lighting assembly. The power supply of the lighting assembly is provided by the lighting and equipment controller component, which is a 24V DC power supply and cannot directly drive the lighting assembly. The lighting driver component can boost or buck the input power supply so that the lighting assembly works under the optimal voltage or current state. The rated input voltage of the lighting driver component is 24V, supports +21-+30V voltage input, has a maximum output power of 15 W, and can work normally at −20° C.-60° C. The lighting driver includes 9 identical drive units. As shown in FIG. 11, the internal architecture diagram of the lighting driver unit is shown. The drive unit includes one boost driver and one buck driver.

In this embodiment, other external systems can control the environmental control system through CAN communication instructions. In order to improve the control efficiency, the state information of each component in the environmental control system is divided into five groups of state information: the first group of state information includes the total state of the lighting and equipment controller, the second group of state information includes the state of the arm light group and the flashing light group, the third group of state information includes the state of the cabin light group and the fan group; the fourth group of state information includes the state of the headlight group; the fifth group of state information includes the state of the digital input signal and the seat belt group.

In this embodiment, the total state of the lighting and equipment controller includes information such as voltage, current, number of components, internal ambient temperature, etc., the arm light group includes 8 navigation lights and 2 clearance lights, the flashing light group includes 3 anti-collision lights, the cabin light group includes an atmosphere light and a reading light, the headlight group includes a startup light and a take-off light, the fan group includes 2 fans, and the seat belt group includes 2 seat belts.

### Embodiment 2

In this embodiment, an unmanned aerial vehicle includes the environmental control system described in Example 1, and also includes a flight control system, a human-computer interaction system and an electrical system.

The electrical system is used to provide power to the environmental control system; the flight control system and the human-computer interaction system send control instructions to the environmental control system and receive state information fed back by the environmental control system. Together with other systems, they form a complete unmanned aerial vehicle control system to enable the aerial vehicle to operate normally.

In this embodiment, the operating mode of the light component is controlled by the lighting and equipment controller, and the state information of each component under different operating modes is collected, which improves the interactivity of the system, ensures the safety of night flight of aerial vehicle, and improves the user experience. The preferred embodiments of the present disclosure are described above with reference to the accompanying drawings, but the scope of the claims of the present disclosure is not limited thereto. Any modifications, equivalent substitutions and improvements made by those skilled in the art without departing from the scope and essence of the present disclosure should be within the scope of the claims of the present disclosure.

### INDUSTRIAL APPLICABILITY

The present disclosure proposes a set of environmental control systems based on unmanned aerial vehicles and unmanned aerial vehicles, through a lighting and equipment controller, a lighting driver, a light component, a fan and a signal input interface, the lighting and equipment controller is used to receive instructions from an external system, control the lighting driver, the light component and the fan according to the instructions, and obtain the state information of each component in the system through the signal input interface, and feed it back to the corresponding external system; the lighting driver boosts or bucks the power provided by the lighting and equipment controller, and then drives each light component with a constant current. The operating mode of the light component is controlled by the lighting and equipment controller, and the state information of each component under different operating modes is collected, which improves the interactivity of the system and ensures the safety of night flight of aerial vehicle. Therefore, it has industrial applicability.

1. An environmental control system based on an unmanned aerial vehicle, comprising:
a lighting and equipment controller,
a lighting driver,
a lighting assembly,
a fan, and
a signal input interface;
wherein the lighting and equipment controller is used to receive an instruction from an external system, control the lighting driver, the lighting assembly and the fan according to the instruction, and obtain state information of each component in the system through the signal input interface, and feed the state information back to a corresponding external system; and
the lighting driver boosts or bucks power provided by the lighting and equipment controller, and then drives each lighting assembly with a constant current.

2. The environmental control system based on an unmanned aerial vehicle according to claim 1, wherein the lighting assembly comprises: a navigation light, an anti-collision light, a clearance light, a reading light, an atmosphere light, a startup light, and a take-off light,
wherein the anti-collision light comprises: a top anti-collision light, a left rear anti-collision light and a right rear anti-collision light,
the clearance light comprises: a left clearance light and a right clearance light, and
the navigation light comprises: a red navigation light and a green navigation light.

3. The environmental control system based on an unmanned aerial vehicle according to claim 2, wherein the lighting and equipment controller parses the instruction through a software and switches an operating mode of the lighting assembly; and
the operating mode of the lighting assembly comprises: normally open, special strobe, regular strobe, breathing, dimming, and off.

4. The environmental control system based on an unmanned aerial vehicle according to claim 3, wherein the operating mode of the lighting assembly corresponds to a navigation state of the aerial vehicle, and the navigation state comprises: a charging state, an equipment startup state, a power startup state, an unlock state, a non-automatic state, and a maintenance state.

5. The environmental control system based on an unmanned aerial vehicle according to claim 1, wherein the lighting and equipment controller comprises: a power module, an electronic switch module, an analog signal conversion module, a digital signal conversion module, an isolation CAN module, a serial port level conversion module, a temperature and humidity detection module, a main control module, and an interface.

6. The environmental control system based on an unmanned aerial vehicle according to claim 5, wherein the power module comprises 20 controllable 24V power outputs, each of which has an overcurrent protection function; the digital signal conversion module includes 8 digital signal sampling interfaces, and the analog signal conversion module includes 4 analog signal sampling interfaces.

7. The environmental control system based on an unmanned aerial vehicle according to claim 1, wherein the lighting driver includes 9 identical drive units, and each drive unit comprises a boost driver and a buck driver.

8. The environmental control system based on an unmanned aerial vehicle according to claim 1, wherein the state information of each component in the system is divided into five groups of state information: a first group of state information comprises a total state of the lighting and equipment controller, a second group of state information comprises a state of an arm light group and a state of a flashing light group, a third group of state information comprises a state of a cabin light group and a state of a fan group; a fourth group of state information comprises a state of a headlight group, and a fifth group of state information comprises a state of a digital input signal and a state of a seat belt group.

9. The environmental control system based on an unmanned aerial vehicle according to claim 1, wherein the external system comprises a flight control system, a human-computer interaction system, and an electrical system.

10. An unmanned aerial vehicle, comprising the environmental control system according to claim 1, and further comprising a flight control system, a human-computer interaction system, and an electrical system.

11. An unmanned aerial vehicle, comprising the environmental control system according to claim 2, and further comprising a flight control system, a human-computer interaction system, and an electrical system.

12. An unmanned aerial vehicle, comprising the environmental control system according to claim 3, and further comprising a flight control system, a human-computer interaction system, and an electrical system.

13. An unmanned aerial vehicle, comprising the environmental control system according to claim 4, and further comprising a flight control system, a human-computer interaction system, and an electrical system.

14. An unmanned aerial vehicle, comprising the environmental control system according to claim 5, and further comprising a flight control system, a human-computer interaction system, and an electrical system.

15. An unmanned aerial vehicle, comprising the environmental control system according to claim 6, and further comprising a flight control system, a human-computer interaction system, and an electrical system.

16. An unmanned aerial vehicle, comprising the environmental control system according to claim 7, and further comprising a flight control system, a human-computer interaction system, and an electrical system.

17. An unmanned aerial vehicle, comprising the environmental control system according to claim 8, and further comprising a flight control system, a human-computer interaction system, and an electrical system.

18. An unmanned aerial vehicle, comprising the environmental control system according to claim 9, and further comprising a flight control system, a human-computer interaction system, and an electrical system.
